(19) United States
(12) Patent Application Publication
(10) Pub. No.: US 2025/0090936 A1
(43) Pub. Date: Mar. 20, 2025

(54) DISPOSAL BOX FOR USED PLAYING CARDS

(71) Applicant: ANGEL GROUP CO., LTD., Shiga (JP)

(72) Inventor: Yasushi SHIGETA, Shiga (JP)

(21) Appl. No.: 18/970,603

(22) Filed: Dec. 5, 2024

Related U.S. Application Data
(63) Continuation of application No. 17/880,979, filed on Aug. 4, 2022.
Application No. 17/880,979 is a continuation of application No. 17/007,716, filed on Aug. 31, 2020, now abandoned.
Application No. 17/007,716 is a continuation of application No. 16/099,923, filed on Nov. 8, 2018, now Pat. No. 10,792,552.

(30) Foreign Application Priority Data
May 13, 2016 (JP) 2016-109416

(51) Int. Cl. A63F 1/06; A63F 1/10; A63F 3/00; A63F 9/24; B65D 25/56; B65F 1/00; B65F 1/02; G07F 17/32

(52) U.S. Cl. CPC A63F 1/062; A63F 1/06; A63F 1/067; B65D 25/56; B65F 1/00; B65F 1/02; A63F 1/10; A63F 3/00157; A63F 2003/00164; A63F 2003/00943; A63F 2009/242; A63F 2250/58; B65D 2203/02; B65F 2210/138; B65F 2210/144; B65F 2250/108; B65F 2250/114; G07F 17/3241; G07F 17/3293

(57) ABSTRACT

A disposal box for used playing cards has a cuboid shape provided with six surfaces, namely, front and back surfaces, left and right surfaces, and upper and lower surfaces in an assembled state. The disposal box includes a slit that is provided in at least one of the six surfaces and enables the used playing cards to be inserted into the disposal box. The disposal box further includes viewing windows that are provided with a plurality of holes having a size at which the playing card cannot be taken out, and can allow the used playing cards contained in the disposal box to be visually recognized. The disposal box is formed of a paper or plastic material, and can be discarded in a state in which the used playing cards are contained in the disposal box.

### CROSS-REFERENCE TO RELATED APPLICATIONS

This application is a continuation of U.S. patent application Ser. No. 17/880,979 filed Aug. 4, 2022, which is a continuation of U.S. patent application Ser. No. 17/007,716 filed Aug. 31, 2020, which is a continuation of U.S. patent application Ser. No. 16/099,923 filed Nov. 8, 2018 (now U.S. Pat. No. 10,792,552), which is the national phase application under 35 U.S.C. § 371 of International Pat. App. PCT/JP2017/017521 filed May 9, 2017, which claims priority to JP Pat. App. 2016-109416 filed May 13, 2016. The entire contents of each application are specifically incorporated by reference herein without disclaimer.

### TECHNICAL FIELD

The present invention relates to a disposal box for used playing cards for preventing the used playing cards from being illegally taken out in a card game and certainly discarding the used playing cards.

### BACKGROUND ART

In various card games such as poker, baccarat, bridge, or blackjack, a dealer sets playing cards of one deck or a plurality of decks on a card shooter or the like, discharges the playing cards of one deck or the plurality of decks one by one from the card shooter or the like, and distributes the playing cards to game participants. In order to prevent the playing cards after being used in the game from being used for illegal purposes, the playing cards after being used in the game should be managed so as not to be lost or stolen by being temporality stored in a plastic case and be then discarded.

For example, International Publication No. 2013/172038 discloses a conventional card disposal system for managing and discarding used playing cards.

Since the conventional card disposal system uses a large-scale card disposal apparatus that confirms on a game table whether or not the number of cards after being used on the game table corresponds to a predetermined number (for example, 52 cards×8 decks=416 cards when 8 decks are used), maintenance of the apparatus is laborious. In addition, cards remaining without being used in the game among the 416 cards also need to pass one by one through the apparatus in order to manage the number of cards, which takes time and effort and hinders an efficient operation of the game. Therefore, it is not appropriate to use the conventional card disposal system in a casino using a large amount of cards.

### SUMMARY OF INVENTION

The present invention has been made in consideration of the above problems, and an object of the present invention is to provide a disposal box for used playing cards capable of easily and certainly discarding the used playing cards in a package unit without the used playing cards being illegally taken out by managing the used playing cards in a package unit including a predetermined number of playing cards (for example, 52 cards×8 decks=416 cards when 8 decks are used) used in a game.

In order to achieve the above object, a disposal box for used playing cards according to the present invention is a disposal box for used playing cards having a cuboid shape provided with six surfaces, namely, front and back surfaces, left and right surfaces, and upper and lower surfaces in an assembled state, and includes a slit that is provided in at least one of the six surfaces of the disposal box and enables the used playing cards to be inserted into the disposal box, viewing windows that are provided in at least one of the front surface, the back surface, the left surface and the right surface of the disposal box in order to confirm an amount or a content of used playing cards contained in the disposal box, and a viewing hole that is provided in the upper surface of the disposal box in order to confirm existence of the used playing cards contained in the disposal box, wherein the viewing windows are provided as a plurality of holes having a size at which the playing card cannot be taken out, and can allow the used playing cards contained in the disposal box to be visually recognized. The disposal box is formed of a paper or plastic material, and can be discarded in a state in which the used playing cards are contained in the disposal box.

According to the present invention, it is possible to easily and certainly discard used playing cards in a package unit without the used playing cards being illegally taken out, which leads to reduction in operation cost, and improvement of safety as well as improvement of workability of a game in a casino.

### BRIEF DESCRIPTION OF DRAWINGS

FIG. 1 is a perspective view of a disposal box according to a first embodiment of the present invention.

FIG. 2 is a front view of the disposal box according to the first embodiment of the present invention in a state in which a slit cover of the disposal box is opened.

FIG. 3 is a front view of the disposal box according to the first embodiment of the present invention in a state in which the slit cover of the disposal box is closed.

FIG. 4 is a right side view of the disposal box according to the first embodiment of the present invention.

FIG. 5 is a plan view of the disposal box according to the first embodiment of the present invention.

FIG. 6 is a bottom view of the disposal box according to the first embodiment of the present invention.

FIG. 7 is a left side view of the disposal box according to the first embodiment of the present invention.

FIG. 8 is a development view of the disposal box according to the first embodiment of the present invention.

FIG. 9 is a right side view illustrating a state in which used playing cards of the disposal box according to the first embodiment of the present utility model are accommodated.

FIG. 10 is an explanatory view illustrating a state in which the used playing cards are discarded in the disposal box according to the first embodiment of the present invention.

FIG. 11 is an explanatory view illustrating a state in which the disposal box according to the first embodiment of the present invention is provided in a game table.

FIG. 12 is a perspective view of a disposal box according to a second embodiment of the present utility model.

FIG. 13 is a front view of the disposal box according to the second embodiment of the present utility model in a state in which a slit cover of the disposal box is opened.

FIG. 14 is a right side view of the disposal box according to the second embodiment of the present invention.

FIG. 15 is a plan view of the disposal box according to the second embodiment of the present invention.

FIG. 16 is a bottom view of the disposal box according to the second embodiment of the present invention.

FIG. 17 is a left side view of the disposal box according to the second embodiment of the present invention.

FIG. 18 is a development view of the disposal box according to the second embodiment of the present invention.

FIG. 19 is a development view of a disposal box according to a third embodiment of the present invention.

### DESCRIPTION OF EMBODIMENTS

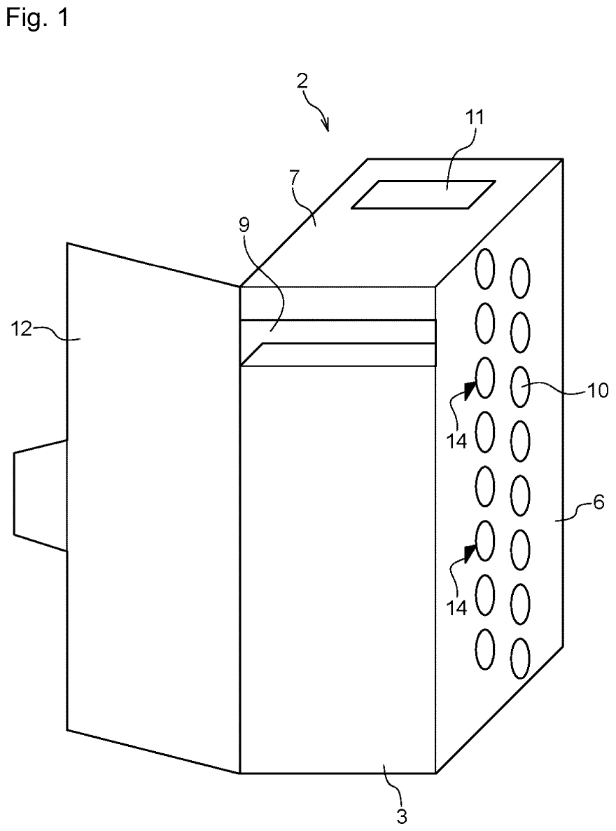

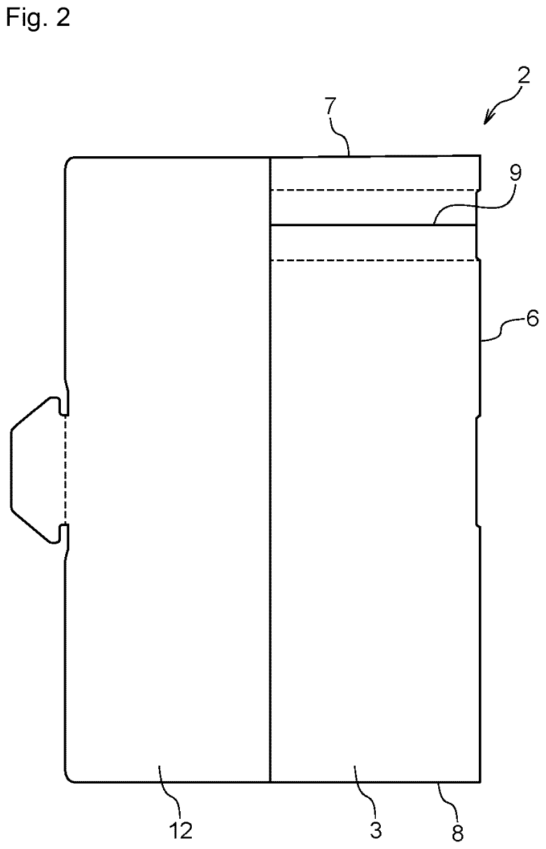

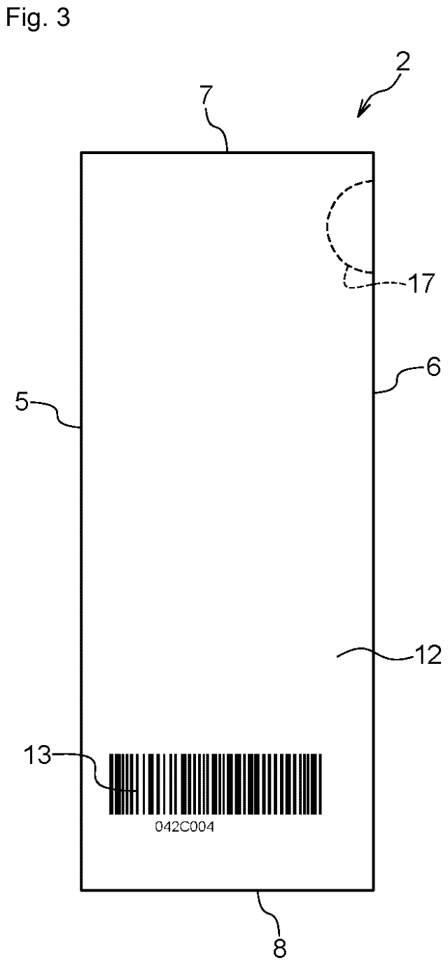

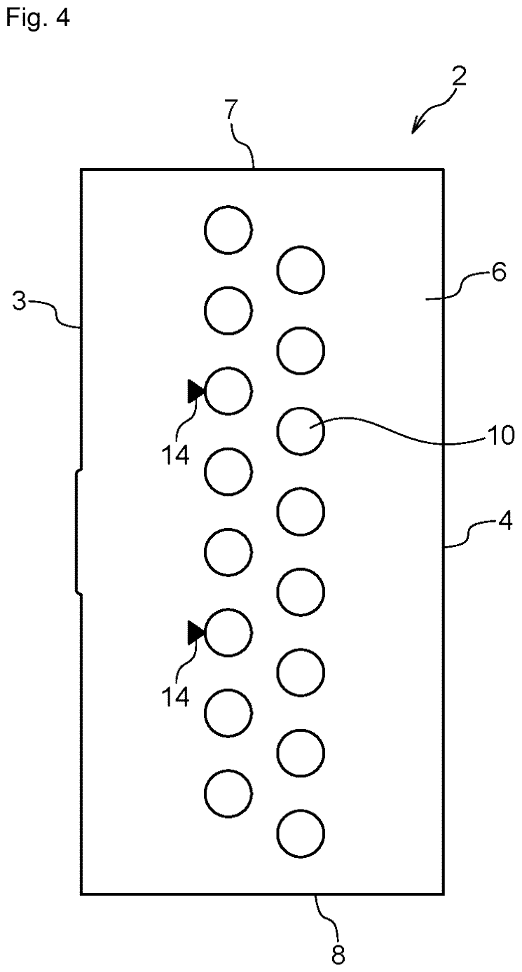

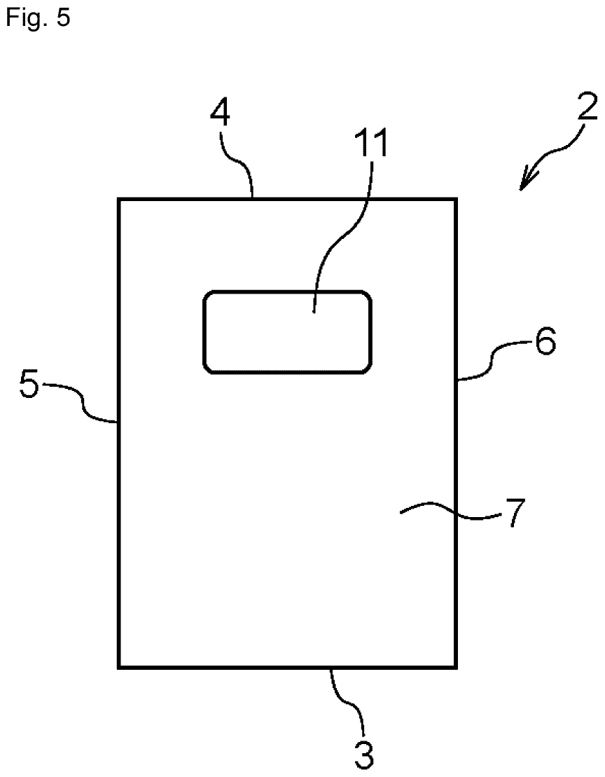

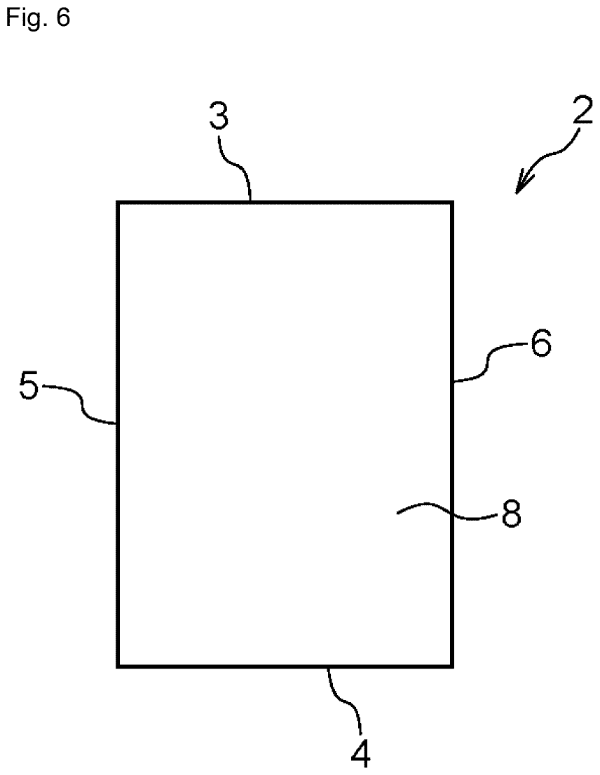

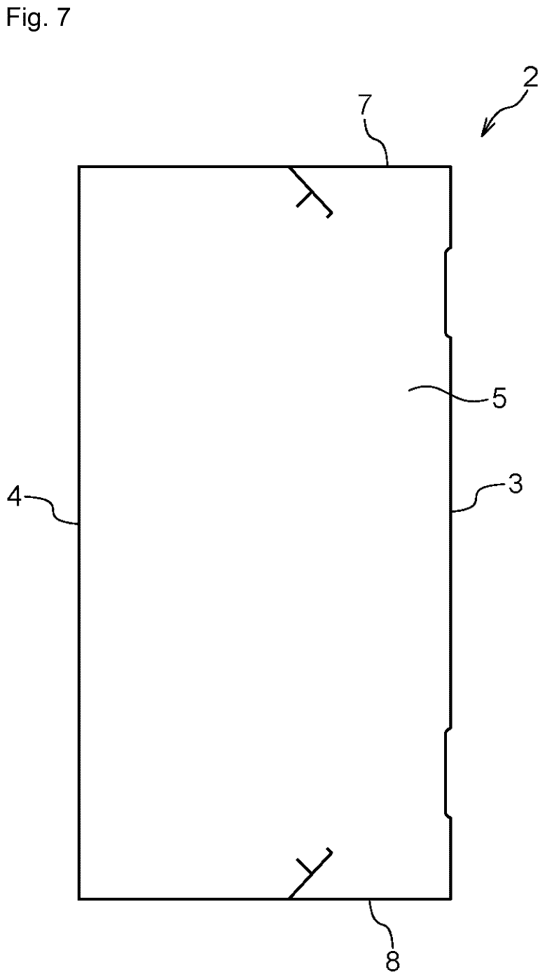

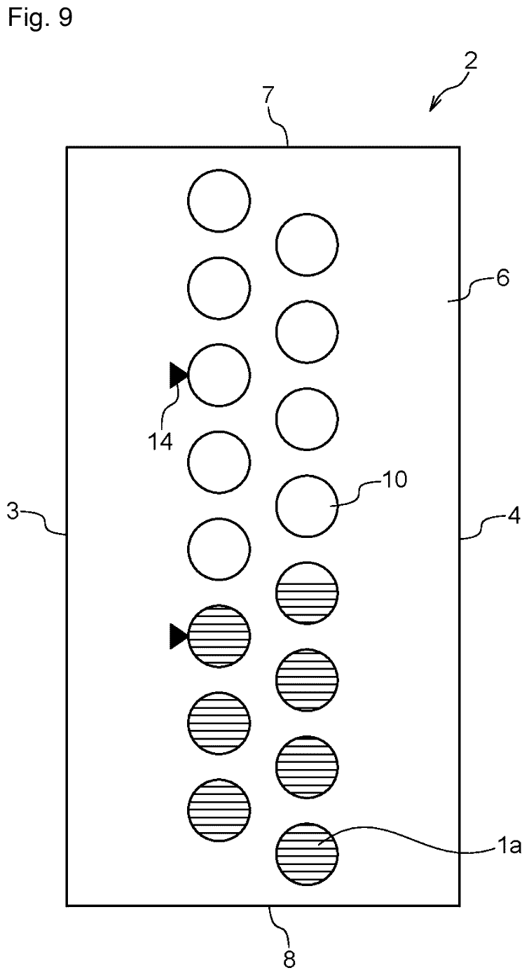

A first embodiment of the present invention will be described with reference to the drawings. FIG. 1 is a perspective view of a disposal box for used playing cards according to a first embodiment of the present invention. FIG. 2 is a front view of the disposal box according to the first embodiment of the present invention in a state in which a slit cover of the disposal box is opened, and FIG. 3 is a front view of the disposal box according to the first embodiment of the present invention in a state in which the slit cover of the disposal box is closed. In addition, FIGS. 4 to 8 are, respectively, a right side view, a plan view, a bottom view, a left side view, and a development view of the disposal box according to the first embodiment of the present invention, and FIG. 9 is a right side view of the disposal box in a state in which used playing cards are accommodated.

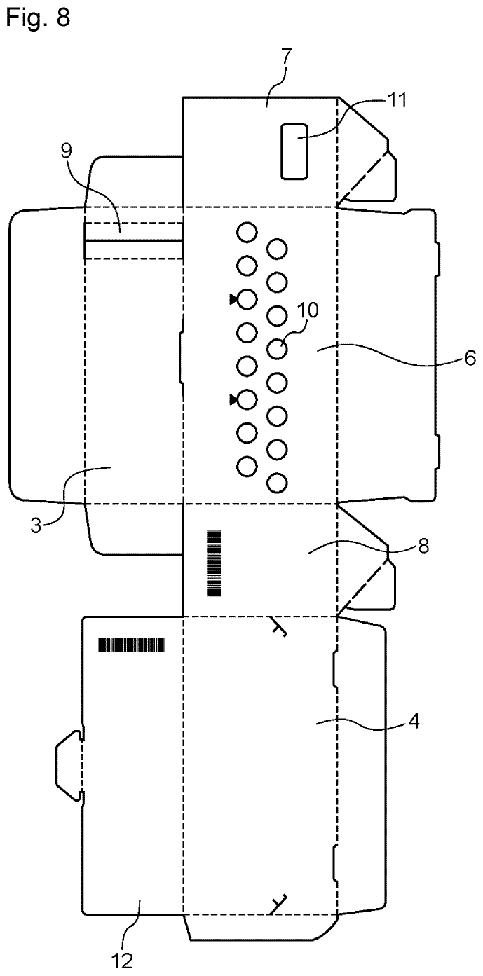

A disposal box 2 for used playing cards has a cuboid shape provided with six surfaces, namely, a front surface 3, a back surface (rear surface) 4, a left surface 5, a right surface 6, an upper surface 7, and a lower surface (bottom surface) 8 in an assembled state. As illustrated in the development view of FIG. 8, the disposal box 2 is composed of a single sheet of material as a whole, and is three-dimensionally assembled as illustrated in FIG. 1 by adhering margin portions to each other. The disposal box 2 is formed of a paper or plastic material. The upper surface 7 and the bottom surface 8 of the disposal box 2 are designed to be slightly larger than the playing cards to be accommodated in the disposal box, and the used playing cards are stacked in a vertical direction to be horizontal to the upper surface 7 and the bottom surface 8 and are accommodated in the disposal box 2.

A slit 9 that enables the used playing cards to be inserted into the disposal box 2 is provided in at least one of the six surfaces of the disposal box 2. In the present embodiment, the slit 9 is provided in an upper part of the front surface 3. The disposal box 2 is further provided with a slit cover 12 covering the slit 9. In addition, a plurality of viewing windows 10 for confirming an amount or a content of used playing cards 1a contained in the disposal box are formed in at least one of the front surface 3, the back surface 4, the left surface 5, and the right surface 6 of the disposal box 2. In the present embodiment, the plurality of viewing windows 10 are formed in the right surface 6. In addition, a viewing hole 11 for confirming existence of the used playing cards 1a contained in the disposal box is formed in the upper surface 7 of the disposal box 2.

As illustrated in FIG. 4, each viewing window 10 is formed as a circular hole. Each viewing window 10 is designed to have a size at which the playing cards accommodated in the disposal box 2 cannot be taken out from the disposal box 2. The plurality of viewing windows 10 form lines side by side in a longitudinal direction, that is, a direction in which the used playing cards are stacked in the disposal box 2. A plurality of (two in the present embodiment) these lines are arranged in a transverse direction, that is, a plane direction of each used playing card accommodated in the disposal box, and the viewing windows 10 are alternately provided between adjacent lines, such that each used playing card 1a contained in the disposal box can always be visually recognized from any one of the holes. In addition, the viewing hole 11 is formed at a size at which the playing cards cannot be taken out. Guide indications 14 that indicate the number of used playing cards contained in the disposal box are attached to the right surface 6 in which the viewing windows 10 are provided.

The disposal box 2 includes the slit cover 12 for sealing the slit 9 after a predetermined number of used playing cards 1a are inserted into the disposal box. The slit cover 12 is provided with a barcode 13 representing an identification code (ID code) different for each disposal box 2. A predetermined number of playing cards 1 are packaged. The playing cards 1 of each package are shuffled, and a card arrangement of the playing cards 1 in each package is unique for each package.

The ID code is given in a format of a barcode to each package in order to specify the corresponding package. The used playing cards 1a used in a game are inserted into the same disposal box 2 in a package unit. A unique ID code associated with the ID code attached to the package is given in the format of the barcode 13 to the disposal box 2. It should be noted that the ID code may be given to the package or the disposal box 2 by printing a content thereof as it is (rather than the format of the barcode).

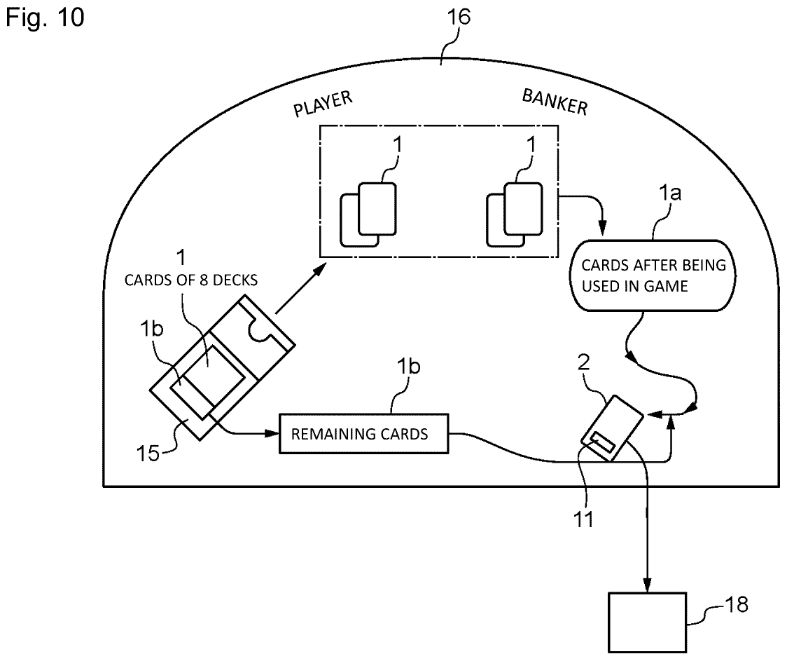

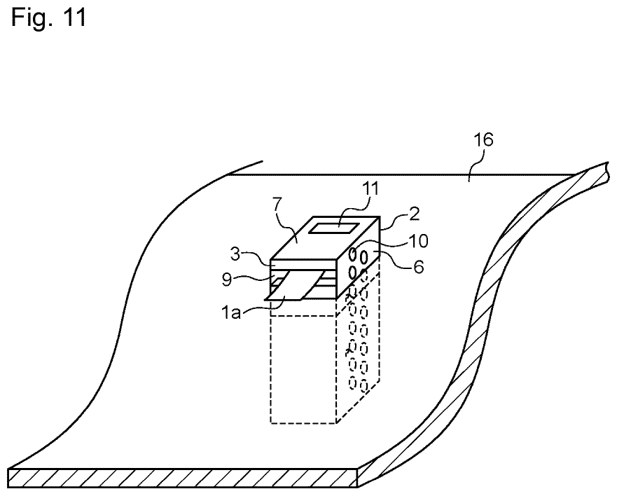

Next, a method of inserting the used playing cards 1a into the disposal box 2 to discard the used playing cards 1a will be described with reference to FIGS. 10 and 11. FIG. 10 is an explanatory view illustrating a state in which the used playing cards are discarded in the disposal box according to the first embodiment of the present utility model, and FIG. 11 is an explanatory view illustrating a state in which the disposal box according to the first embodiment of the present invention is provided in a game table. As illustrated in FIG. 11, a disposal box accommodation hole for burying the disposal box 2 is formed in a table 16, and the disposal box 2 is fitted into and used in the disposal box accommodation hole in a state in which the slit cover 12 is opened. The disposal box accommodation hole has a depth at which the slit 9 formed in the upper part of the front surface 3 is positioned at the same height as that of an upper surface of the table 16 or is positioned at a position slightly higher than the upper surface of the table 16 as illustrated in FIG. 11 when the disposal box 2 is fitted into the disposal box accommodation hole. Therefore, when the disposal box 2 is fitted into the disposal box accommodation hole formed in the table 16, the slit 9 is positioned at the same height as that of the upper surface of the table surface 16 or is positioned at the position slightly higher than that of the upper surface of the table 16.

As illustrated in FIG. 10, after a predetermined number of playing cards 1 (for example, 52 cards×8 decks=416 cards when 8 decks are used) managed in a package unit are received in a shooter 15 used in a casino or the like, the predetermined number of playing cards 1 are distributed to a player (customer) on the game table 16 by a dealer and are used in a game.

The used playing cards 1a used in the game are brought to the disposal box 2 installed in the game table 16 by the dealer, and are inserted into the disposal box 2 through the slit 9. The dealer can visually recognize the stacked uppermost used playing card 1a by looking into the inside of the disposal box 2 from the viewing hole 11 in a state in which the disposal box 2 is fitted into the disposal box accommodation hole of the table 16, such that the dealer can confirm that the used playing cards 1a are accommodated in the disposal box 2 and an approximate amount of the used playing cards 1a accommodated in the disposal box 2.

When both of the used playing cards 1a and the remaining playing cards 1b that are not used in the game are thrown into the disposal box 2 through the slit 9, the dealer pulls up the disposal box 2 from the game table 16. Then, as shown in FIG. 3, the slit cover 12 is closed to cover the slit 9, thereby preventing the used playing cards 1a from coming out from the slit 9. The dealer further sticks a void seal or the like, for stopping the slit cover 12 using a seal sticking position guide 17. Then, the disposal box 2 accommodating the used playing cards 1a is taken into and discarded in a disposal facility 18 in the casino.

When the used playing cards 1a are discarded, the used playing cards 1a contained in each disposal box 2 are discarded. As described above, since the disposal box 2 is formed of the paper or plastic material, the disposal box 2 can be cut by a general cutting machine, and can be incinerated as it is as combustible waste. That is, the disposal box 2 according to the present embodiment is a disposable disposal box. In addition, at the time of discarding the disposal box, it is possible to read the ID code attached to the disposal box 2 and associate the read ID code with an ID of an associated package to leave a record indicating that the disposal box was discarded. In addition, since the disposal box is sealed in a package unit and is managed by the ID code, when there is a case that any disposal box 2 has been lost and not discarded, such a case can be found.

In addition, in the above embodiment, the slit 9 is provided in the front surface 3, but the slit 9 may be provided in the other surface. Further, in the above embodiment, the viewing holes 10 are provided in the right surface, but the viewing holes 10 may be provided in any one of the front surface 3, the back surface 4, and the left surface 5.

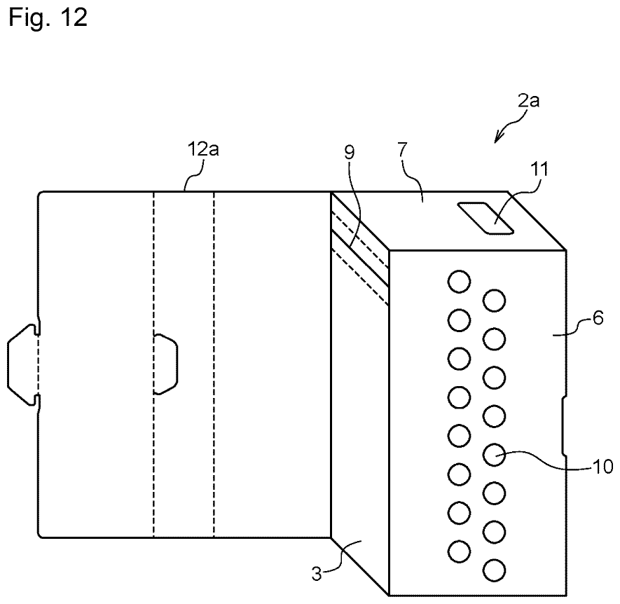

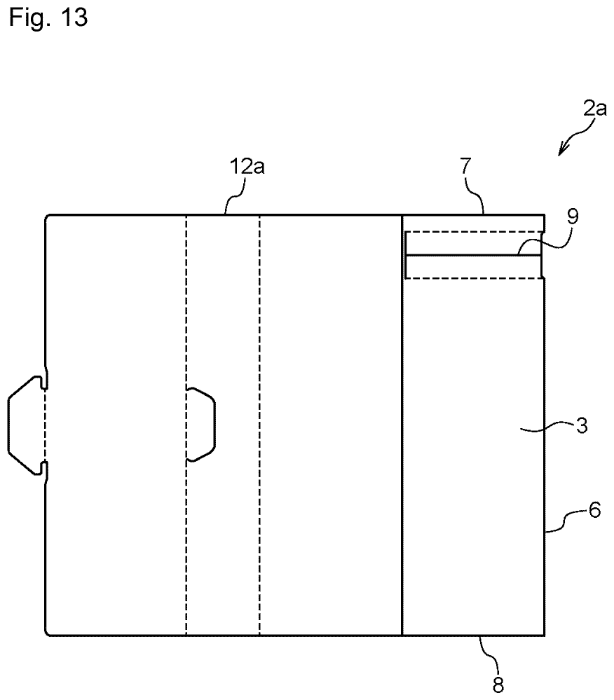

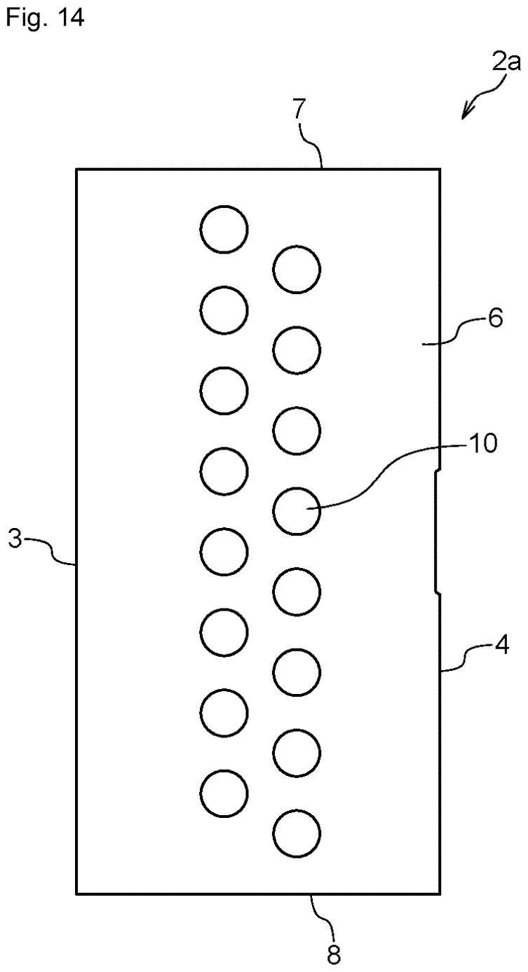

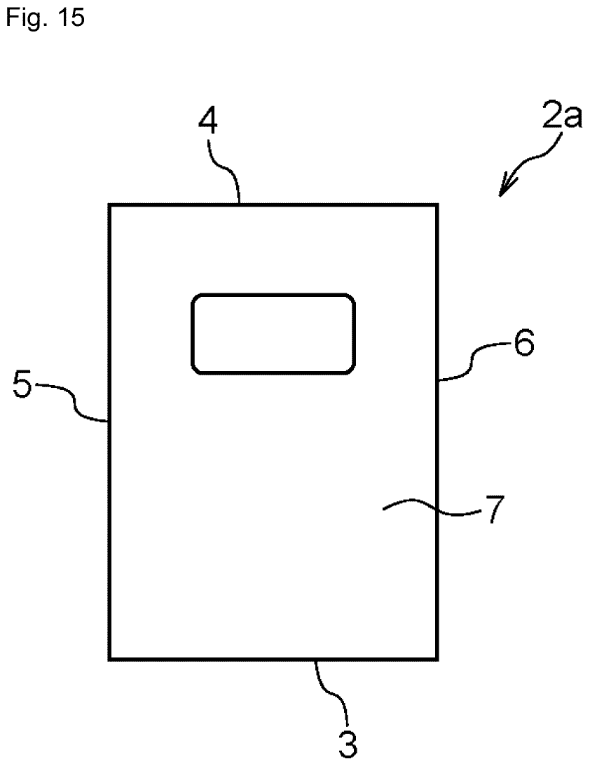

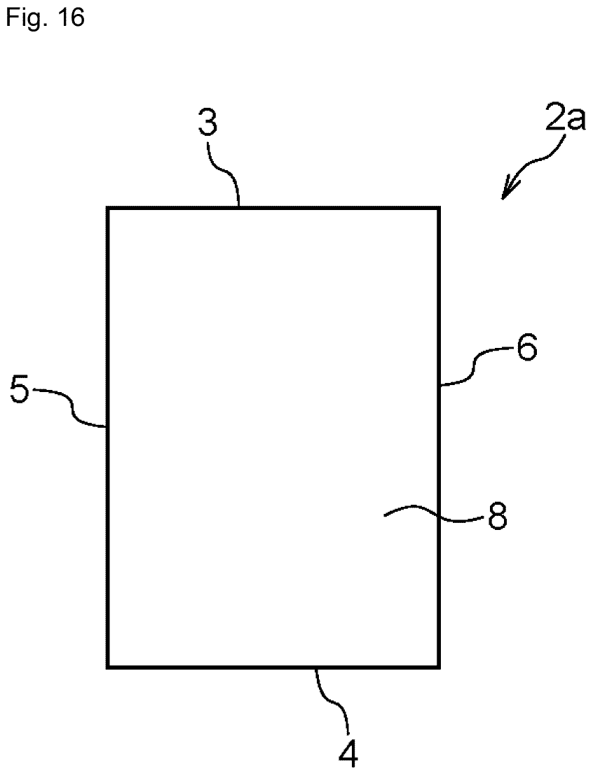

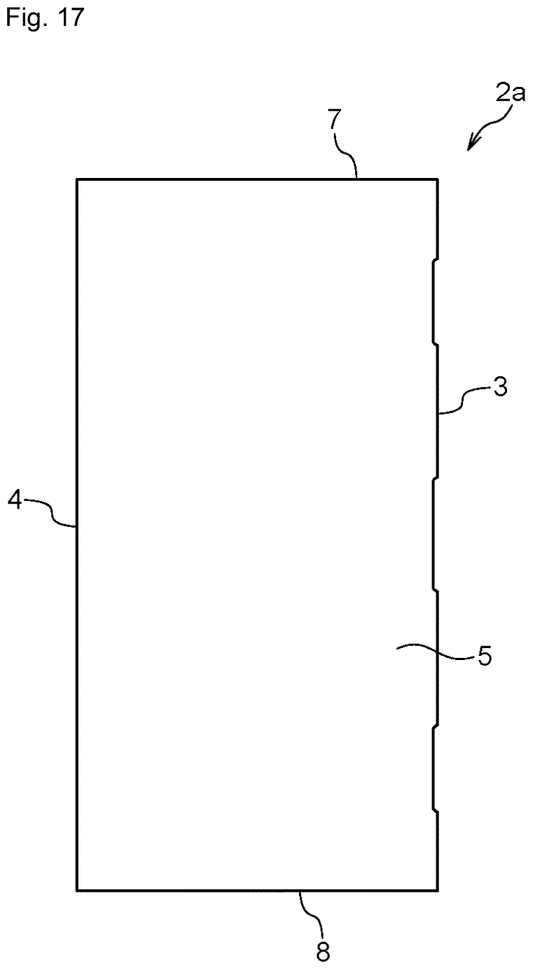

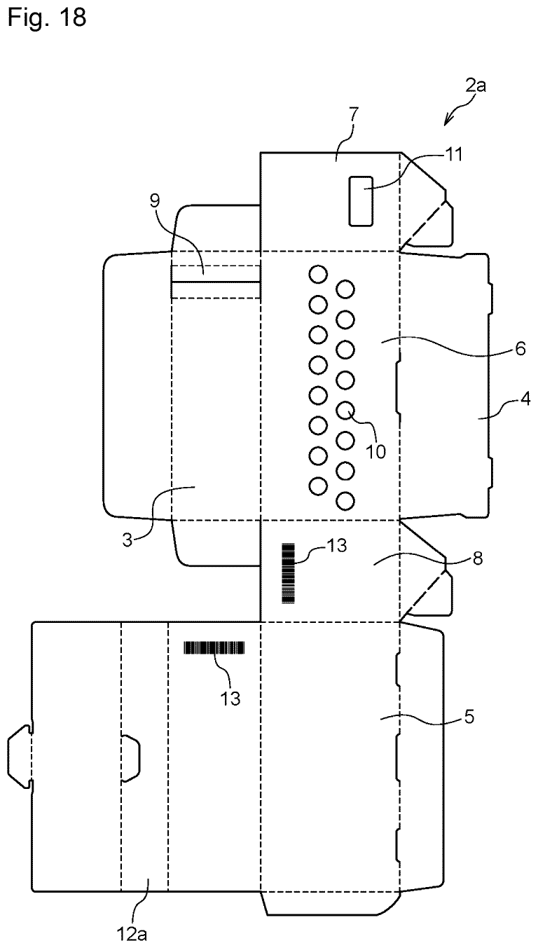

FIG. 12 is a perspective view of a disposal box according to a second embodiment of the present invention. In addition, FIG. 13 is a front view of the disposal box according to the second embodiment of the present invention, and illustrates a state in which a slit cover 12a is opened. FIGS. 14 to 18 are, respectively, a right side view, a plan view, a bottom view, a left side view, and a development view of the disposal box according to the second embodiment of the present invention. In a disposal box 2a of FIGS. 12 to 18, the same components as those of the disposal box 2 according to the first embodiment are denoted by the same reference numerals, and a description thereof is omitted.

The disposal box 2a according to the second embodiment of the present invention is different from the disposal box 2 according to the first embodiment in that the slit cover 12a has a structure in which it covers both of a slit 9 and viewing windows 10. That is, as illustrated in FIGS. 12, 13, and 18, the slit cover 12 has a sufficient width, such that the slit cover 12 can cover a front surface 3 in which the slit 9 is provided and a right surface in which a plurality of viewing holes 10 are provided.

The disposal box 2a is fitted into a disposal box accommodation hole of a table 16 in a state in which the slit cover 12a is opened. When a predetermined number of used playing cards 1a are accommodated in the disposal box, a dealer takes the disposal box 2a out of the disposal box accommodation hole of the table 16, and covers the front surface 3 and the right surface 6 by the slit cover 12a. As in the first embodiment, after the slit cover 12a is closed in this way, a void seal or the like, for stopping the slit cover 12 may further be stuck.

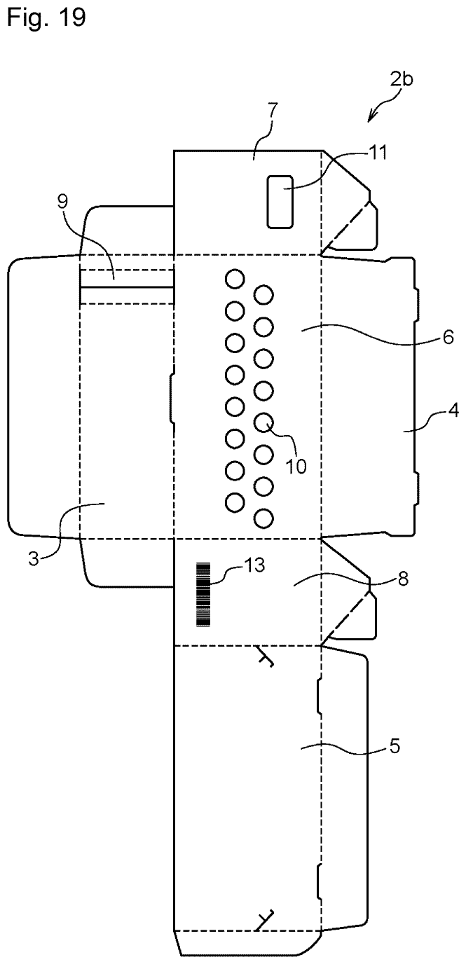

FIG. 19 is a development view of a disposal box according to a third embodiment of the present invention. In FIG. 19, the same components as those of the disposal box 2 according to the first embodiment are denoted by the same reference numerals, and a description thereof is omitted. The disposal box 2b according to the present embodiment has a structure in which a slit cover 12 does not exist. In the present embodiment, after a predetermined number of used playing cards 1a are accommodated in the disposal box 2, a seal for sealing the slit 9 is stuck so as to close the slit 9.

The disposal box for used playing cards used in the table game according to the present invention can easily and certainly discard the used playing cards in a package unit without the used playing cards being illegally taken out, which leads to reduction in operation cost, and improvement of safety as well as improvement of workability of the game. Therefore, the disposal box for used playing cards is useful for a table game in casino or the like.

1. A disposal box for accommodating used playing cards for disposal, the disposal box comprising:
six sides formed by one continuous paper or plastic material; and
a slit through which the used playing cards are insertable into the disposal box, wherein the disposal box is discardable together with the used playing cards in a state in which the used playing cards are contained in the disposal box.

2. The disposal box according to claim 1, wherein, when the disposal box is positioned on a game table, the slit is positioned at a same height as or higher than that of an upper surface of the game table.

3. The disposal box according to claim 1, wherein a viewing window for confirming an amount of used playing cards contained in the disposal box is provided in at least one of a front surface, a back surface, a left surface, and a right surface of the disposal box.

4. The disposal box according to claim 3, wherein a guide indication indicating a number of the used playing cards that are contained in the disposal box is further attached to the surface in which the viewing window is provided.

5. The disposal box according to claim 1, wherein a plurality of viewing windows for confirming an amount of used playing cards contained in the disposal box are provided in at least one of a front surface, a back surface, a left surface, and a right surface of the disposal box, and each of the plurality of viewing windows has a size at which the used playing cards contained in the disposal box cannot be taken out of the disposal box.

6. The disposal box according to claim 5, wherein the plurality of viewing windows form columns side by side in a plane direction of each used playing card accommodated in the disposal box, the columns each extends in a direction in which the used playing cards are stacked in the disposal box, and the viewing windows of adjacent ones of the side by side columns are alternately provided, such that each used playing card contained in the disposal box can always be visually recognized from at least one of the viewing windows.

7. The disposal box according to claim 1, wherein a viewing hole for viewing at least one of the used playing cards accommodated in the disposal box is formed on an upper surface of the disposal box.

8. The disposal box according to claim 1, further comprising a slit cover or a seal for sealing the slit after a predetermined number of the used playing cards are inserted into the disposal box.

9. The disposal box according to claim 8, wherein a sticking position of the seal that limits opening and closing of the slit cover after the slit is sealed is marked on the slit cover.

10. The disposal box according to claim 1, wherein a printing or a barcode indicating a unique identification (ID) is assigned to each set of the used playing cards.

11. The disposal box according to claim 1, wherein the disposal box can be cut with a cutter or incinerated as combustible waste.

12. The disposal box according to claim 1, wherein the used playing cards are brought into a disposal facility in the casino and discarded.

13. An arrangement for disposal of used playing cards for disposal, the arrangement comprising:
a game table; and
a disposal box that comprises:
six sides formed by one continuous paper or plastic material; and
a slit through which the used playing cards are insertable into the disposal box, wherein the disposal box:
is positioned on the game table such that the slit is at a same height as or higher than that of an upper surface of the game table;
is removable from the game table; and
is discardable, after removal from the game table, together with the used playing cards in a state in which the used playing cards are contained in the disposal box.
